(19) United States
(12) Patent Application Publication
(10) Pub. No.: US 2015/0287119 A1
(43) Pub. Date: Oct. 8, 2015

(54) PRESENTATION OF ITEMS OF VALUE FOR PURCHASE

(71) Applicant: Rukkus, Inc., New York, NY (US)

(72) Inventors: Manick Bhan, Belle Mead, NJ (US); Angela McCrory, Dallas, TX (US); Joseph Messineo, New York, NY (US); Sanjay Waza, San Jose, CA (US)

(21) Appl. No.: 14/680,958

(22) Filed: Apr. 7, 2015

Related U.S. Application Data
(60) Provisional application No. 61/976,463, filed on Apr. 7, 2014.

(51) Int. Cl. G06Q 30/06; G06Q 10/02

(52) U.S. Cl. CPC G06Q 30/0629; G06Q 10/02; G06Q 30/0627

(57) ABSTRACT

Disclosed are systems, media, and methods for efficiently presenting location-based ticket information comprising: providing an interface presenting location-specific information about upcoming events; providing an interface allowing a user to indicate preferences; aggregating ticket listings for a selected event from primary and secondary market vendors, each ticket listing comprising a price; a software module configured to apply an algorithm identify a group of suitable ticket listings and generate a ticket value score for each ticket listing based, at least in part, on the user preferences and the price; providing an interface presenting the ticket listings for an event as pins on a map of an event venue, each pin indicating a price, each pin positioned on the map to indicate section and row of the ticket listing; and obfuscating ticket listings that are a higher price and lower ticket value score than a presented or selected ticket listing.

### CROSS-REFERENCE TO RELATED APPLICATIONS

This application claims the benefit of U.S. App. Ser. No. 61/976,463, filed Apr. 7, 2014, which is hereby incorporated by reference in its entirety.

### TECHNICAL FIELD OF THE INVENTION

This disclosure relates to systems and methods for presenting event ticket information.

### BACKGROUND OF THE INVENTION

The market for tickets to sports, theater, concert, and all other types of events is fragmented across many different primary, secondary, and hybrid vendors that offer both primary and secondary market inventory. Primary ticket sellers are those with whom a given set of tickets to an event originate. Typically, for a given event, there is only one primary vendor. Secondary ticket sellers sell tickets which have first been bought from the primary seller. Secondary ticket sellers may price a given ticket below, at, or above that initially set by the primary seller. Secondary ticket sellers may sell via their own mechanisms and networks, or via a ticket marketplace. Entities that offer both primary and secondary market tickets may or may not be a primary or secondary ticket vendor themselves.

### SUMMARY OF THE INVENTION

It is hereby disclosed that an entity (e.g., Rukkus, Inc.) optionally offers both primary and secondary market tickets, and/or can display information originating from both primary and secondary sellers in order to offer a comprehensive events listing. The event ticket information is optionally presented to users in the context of an application software interface (e.g., a native “app”) installed on mobile or desktop computing devices or in the context of a responsive website interface or web app accessible via the internet by mobile or desktop computing devices. These various application interfaces optionally retrieve data from a network-based system that accesses ticket information from a variety of secondary and primary market vendors. The following outlines systems and methods of sorting and representing ticket inventory retrieved from a variety of sources in a way that is amenable to the user, whether on a desktop or mobile computing device.

Systems and methods are outlined that provide organization to event information in order to aid a user in finding events that suit their interests. Additional systems and methods are outlined that organize information about available tickets to a given event in a way that aids users in the decision to buy a given ticket group out of a multitude of other available ticket groups.

There is a need for a methodology and supporting system that aids the ticket selection process for the consumer. For general admission events, consumers optionally consider only one variable in their decision making process: price. For assigned seating events, in some embodiments, there are multiple variables: price, location, angle of variance to the venue center of interest, and a myriad of others. As a general rule of thumb, price and location can be highly correlated (e.g., the closer the seat is to the action, the higher the price). Therefore, when a consumer is trying to pinpoint the ideal ticket for themselves, they might typically make a series of binary decisions: “What do I gain if I pay a little more?” and “What do I lose if I pay a little less?” Currently, there is no platform that directly helps the consumer with this decision making process.

Entities that offer large inventories of tickets, whether their own inventory or an aggregate listing from multiple vendors, display that inventory in many different ways. Ticket inventory is optionally listed in order of price, by section of event venue, by some perceived value that may or may not be at least partially based on price and/or section of event venue; or it is optionally displayed by location on a venue map. Regardless of how the inventory is displayed, it is generally up to the consumer to search dozens, or at times thousands, of tickets to find the ticket(s) that best suits their needs. The “best ticket” to an individual buyer is contingent on that buyer's budget and desired quality (e.g., distance to the action or focal point of the event (e.g., the stage or field of play)). Some processes of finding the best ticket are very time consuming when the available ticket inventory is not presented to a consumer in a manageable or clear way.

Systems and methods of this disclosure can give users an application interface to a) access a central hub of information about upcoming events and b) easily browse ticket listings originating across multiple vendors and marketplaces in one place in order to cross-compare (i) prices for available tickets to a given event or across multiple events, and (ii) seating/ticket quality within an event venue. All of this information is optionally displayed in reference to the user's geolocation and event interests or preferences.

Some vendor websites do not have a corresponding application accessible by mobile devices, and thus have limited functionality pertaining to a mobile user's needs.

This disclosure provides methods, systems, and application interfaces (e.g., applications or websites) which enable users to search and buy tickets to sports, concerts, theater, and other events, which originate from a multitude of different external vendors, in accordance with their particular budget and seat quality preferences and needs.

This disclosure provides an application interface to a user for ticket and event search capabilities by utilizing a network (e.g., the internet), a user's computing device coupled to that network, and a database of tickets to upcoming events coupled to that network.

In some embodiments, the application interface identifies a user's location in order to provide location-specific event information (e.g., either based on location information directly supplied by the user or from one or more sensors of the user's computing device, such as a GPS receiver).

In some embodiments, the application interface accesses the names of entities (e.g., musicians, sports teams, etc.) or other data stored on a user's computing device or gathered via a third party service (e.g., Pandora, Spotify, Facebook, etc.) in order to identify pertinent events to display to the user.

Through various partnerships and affiliations with ticket vendors and marketplaces, the application, in some embodiments, imports and displays available ticket inventory information as well as additional information pertinent to a given ticketed event. Information displayed to the user, in some cases, pertains to price or price range, location, and availability of tickets for a given event.

In some embodiments, the application augments event listing information with event associated music/multimedia files.

In some embodiments, each ticket and/or grouping of tickets accessed for a given event is scored according to a process (e.g., an algorithm) that determines whether the ticket and/or grouping of tickets is of high or low value on a relative basis. In further embodiments, for a given event, for a desired quantity of adjacent seats, seat quality is analyzed in comparison to the price of each ticket in that ticket group. In this way, the application suggests the relative best ticket group for the user, based on that user's seating quantity requirements and price preferences and any other preferences of the user that may be known or accessible. This mechanism aids the buyer's decision-making process when choosing from all available tickets.

In some embodiments, for a given event, the application interface pinpoints and displays for users the best valued ticket or grouping of tickets based on the above-mentioned scoring process, as are available at a particular moment in time.

In some embodiments, users are given the binary choice to view either lower priced tickets or better quality seats (e.g., as compared to the initially pinpointed best valued ticket or grouping of tickets) within the parameters of the scoring process. In a stepwise manner, the user optionally view ticket group options sequentially by choosing to view less expensive or closer tickets. Depending on the type of venue or event, seat quality is determined, e.g., by the process/algorithm disclosed herein, using a set of parameters that includes, by way of non-limiting examples, the seat's proximity and or angle of variance to the action/performance, or other factors specific to the venue or event type that might determine a seat, row, or section's desirability.

The user is, in some embodiments, given the option to view a photographic or simulated representation of the view from a given seat or section associated with a ticket or group of tickets being currently displayed to the user.

In one aspect, disclosed herein are computer-implemented systems for efficiently presenting location-based ticket information comprising: a digital processing device comprising an operating system configured to perform executable instructions and a memory; a computer program including instructions executable by the digital processing device to create an application comprising: a software module configured to provide an interface presenting location-specific information about upcoming events; a software module configured to provide an interface allowing a user to indicate preferences; a software module configured to aggregate ticket listings for a selected event from primary and secondary market vendors, each ticket listing comprising a price; a software module configured to apply an algorithm identify a group of suitable ticket listings and generate a ticket value score for each ticket listing based, at least in part, on the user preferences and the price; a software module configured to provide an interface presenting the ticket listings for an event as pins on a map of an event venue, each pin indicating a price, each pin positioned on the map to indicate section and row of the ticket listing; and a software module configured to obfuscate or diminish ticket listings that are a higher price and lower ticket value score than a presented or selected ticket listing. In some embodiments, the user seating preferences include one or more of: price, price range, date, date range, distance of event focal point from user, location radius, venue, and performer or team. In some embodiments, the ticket value score is further based, at least in part, on one or more of: properties of the seat, row, or section, properties of the event, properties of the user, and properties of the venue. In some embodiments, the pins are color coded to indicate price or ticket value, the color coding utilizing a gradient of shades of a color. In further embodiments, price and/or ticket value are indicated to the user with a combination of color coding as well as iconographic means. In a particular embodiment, particularly good deals, based on price and value or quality, are highlighted by, for example, color, size, or inclusion of an icon. In some embodiments, the price is presented within the pin for a ticket listing. In some embodiments, the application further comprises a software module configured to present a ticket listing next best to a presented or selected ticket listing. In some embodiments, the application further comprises a software module configured to present a ticket listing next best for a lower price than a presented or selected ticket listing. In some embodiments, the interface presenting location-specific information about upcoming events presents media files associated with the events. In some embodiments, the application further comprises a software module configured to allow a user to search, track, or share upcoming events.

In another aspect, disclosed herein are non-transitory computer-readable storage media encoded with a computer program including instructions executable by a processor to create an application for efficiently presenting location-based ticket information, the application comprising: a software module configured to provide an interface presenting location-specific information about upcoming events; a software module configured to provide an interface allowing a user to indicate preferences; a software module configured to aggregate ticket listings for a selected event from primary and secondary market vendors, each ticket listing comprising a price; a software module configured to apply an algorithm identify a group of suitable ticket listings and generate a ticket value score for each ticket listing based, at least in part, on the user preferences and the price; a software module configured to provide an interface presenting the ticket listings for an event as pins on a map of an event venue, each pin indicating a price, each pin positioned on the map to indicate section and row of the ticket listing; and a software module configured to obfuscate or diminish ticket listings that are a higher price and lower ticket value score than a presented or selected ticket listing. In some embodiments, the user seating preferences include one or more of: price, price range, date, date range, distance of event focal point from user, location radius, venue, and performer or team. In some embodiments, the ticket value score is further based, at least in part, on one or more of: properties of the seat, row, or section, properties of the event, properties of the user, and properties of the venue. In some embodiments, the pins are color coded to indicate price or ticket value, the color coding utilizing a gradient of shades of a color. In further embodiments, price and/or ticket value are indicated to the user with a combination of color coding as well as iconographic means. In a particular embodiment, particularly good deals, based on price and value or quality, are highlighted by, for example, color, size, or inclusion of an icon. In some embodiments, the price is presented within the pin for a ticket listing. In some embodiments, the application further comprises a software module configured to present a ticket listing next best to a presented or selected ticket listing. In some embodiments, the application further comprises a software module configured to present a ticket listing next best for a lower price than a presented or selected ticket listing. In some embodiments, the interface presenting location-specific information about upcoming events presents media files associated with the events. In some embodiments, the application further comprises a software module configured to allow a user to search, track, or share upcoming events.

In another aspect, disclosed herein are computer-implemented methods of efficiently presenting location-based ticket information comprising: presenting, by a computer, location-specific information about upcoming events; providing, by the computer, an interface allowing a user to indicate preferences; aggregating, by the computer, ticket listings for a selected event from primary and secondary market vendors, each ticket listing comprising a price; applying, by the computer, an algorithm to identify a group of suitable ticket listings and generate a ticket value score for each ticket listing based, at least in part, on the user preferences and the price; presenting, by the computer, the ticket listings for an event as pins on a map of an event venue, each pin indicating a price, each pin positioned on the map to indicate section and row of the ticket listing; and obfuscating or diminishing, by the computer, ticket listings that are a higher price and lower ticket value score than a presented or selected ticket listing. In some embodiments, the user seating preferences include one or more of: price, price range, date, date range, distance of event focal point from user, location radius, venue, and performer or team. In some embodiments, the ticket value score is further based, at least in part, on one or more of: properties of the seat, row, or section, properties of the event, properties of the user, and properties of the venue. In some embodiments, the pins are color coded to indicate price or ticket value, the color coding utilizing a gradient of shades of a color. In further embodiments, price and/or ticket value are indicated to the user with a combination of color coding as well as iconographic means. In a particular embodiment, particularly good deals, based on price and value or quality, are highlighted by, for example, color, size, or inclusion of an icon. In some embodiments, the price is presented within the pin for a ticket listing. In some embodiments, the method further comprises presenting, by the computer, a ticket listing next best to a presented or selected ticket listing. In some embodiments, the method further comprises presenting, by the computer, a ticket listing next best for a lower price than a presented or selected ticket listing. In some embodiments, the location-specific information about upcoming events comprises media files associated with the events. In some embodiments, the method further comprises presenting, by the computer, an interface allowing a user to search, track, or share upcoming events.

### BRIEF DESCRIPTION OF THE DRAWINGS

The discussion below makes reference to the following drawings, in which like reference characters may refer to like parts throughout, and in which:

FIG. 1 is an example of a screenshot of an initial page of a ticket search application interface (e.g., application or website accessed by and displayed to a user by a computing device), which may provide event information relevant to a user's location and event preferences;

FIG. 2 is an example of a screenshot of a media sampling page of a ticket search application interface that may be provided for certain event talent (e.g., musical recording artists, musical theatre performers, comedians, sports teams, or the like);

FIG. 3 is an example of a screenshot of a search page with a sample input of a ticket search application interface;

FIG. 4 is an example of a screenshot of an event listings page for a given performer, team, or venue of a ticket search application interface;

FIG. 5A is an example of a screen shot of an event page without a venue map of a ticket search application interface;

FIG. 5B is an example of a screen shot of an event page including a venue map of a ticket search application interface;

FIG. 6 is an example of a screen shot of a payment page of a ticket search application interface;

FIG. 7 is an example graph illustrating the pricing dynamics for tickets to a sample event, which illustrate seat quality on the x-axis and price per ticket on the y-axis;

FIG. 8 is an example of a screen shot of an event page including a venue map of a ticket search application interface, in this case, an interface allowing a user to select from available aggregated ticket listings and preview the view of the venue from a selected location;

FIG. 9 is an example of a screen shot of an event page including a venue map of a ticket search application interface, in this case, an interface including a color-coded slider control to adjust the price range of the displayed ticket listings;

FIG. 10 is an example of a screen shot of an event page including a venue map of a ticket search application interface, in this case, an interface zoomed in to reveal additional ticket listing options and details;

FIG. 11A is an example of an interface for specifying desired ticket listing parameters, in this case, an interface including a two-ended, color-coded price range slider control; and

FIG. 11B is an example of a screen shot of an event page including a venue map of a ticket search application interface, in this case, an interface displaying aggregated ticket listings, which are color-coded to the price range slider of FIG. 11A and indicated by pins on the venue map demonstrating position within the section.

FIG. 11C is an example of a screen shot of an event page including a venue map of a ticket search application interface, in this case, a zoomed-in interface displaying aggregated ticket listings, which are color-coded to a price range slider and indicated by pins on the venue map demonstrating position within the section.

### DETAILED DESCRIPTION OF THE INVENTION

Described herein, in certain embodiments, are computer-implemented systems for efficiently presenting location-based ticket information comprising: a digital processing device comprising an operating system configured to perform executable instructions and a memory; a computer program including instructions executable by the digital processing device to create an application comprising: a software module configured to provide an interface presenting location-specific information about upcoming events; a software module configured to provide an interface allowing a user to indicate preferences; a software module configured to aggregate ticket listings for a selected event from primary and secondary market vendors, each ticket listing comprising a price; a software module configured to apply an algorithm identify a group of suitable ticket listings and generate a ticket value score for each ticket listing based, at least in part, on the user preferences and the price; a software module configured to provide an interface presenting the ticket listings for an event as pins on a map of an event venue, each pin indicating a price, each pin positioned on the map to indicate section and row of the ticket listing; and a software module configured to obfuscate or diminish ticket listings that are a higher price and lower ticket value score than a presented or selected ticket listing.

Also described herein, in certain embodiments, are non-transitory computer-readable storage media encoded with a computer program including instructions executable by a processor to create an application for efficiently presenting location-based ticket information, the application comprising: a software module configured to provide an interface presenting location-specific information about upcoming events; a software module configured to provide an interface allowing a user to indicate preferences; a software module configured to aggregate ticket listings for a selected event from primary and secondary market vendors, each ticket listing comprising a price; a software module configured to apply an algorithm identify a group of suitable ticket listings and generate a ticket value score for each ticket listing based, at least in part, on the user preferences and the price; a software module configured to provide an interface presenting the ticket listings for an event as pins on a map of an event venue, each pin indicating a price, each pin positioned on the map to indicate section and row of the ticket listing; and a software module configured to obfuscate or diminish ticket listings that are a higher price and lower ticket value score than a presented or selected ticket listing.

Also described herein, in certain embodiments, are computer-implemented methods of efficiently presenting location-based ticket information comprising: presenting, by a computer, location-specific information about upcoming events; providing, by the computer, an interface allowing a user to indicate preferences; aggregating, by the computer, ticket listings for a selected event from primary and secondary market vendors, each ticket listing comprising a price; applying, by the computer, an algorithm to identify a group of suitable ticket listings and generate a ticket value score for each ticket listing based, at least in part, on the user preferences and the price; presenting, by the computer, the ticket listings for an event as pins on a map of an event venue, each pin indicating a price, each pin positioned on the map to indicate section and row of the ticket listing; and obfuscating or diminishing, by the computer, ticket listings that are a higher price and lower ticket value score than a presented or selected ticket listing.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, “obfuscate” means to deemphasize, diminish, obscure, or remove from the view of the user.

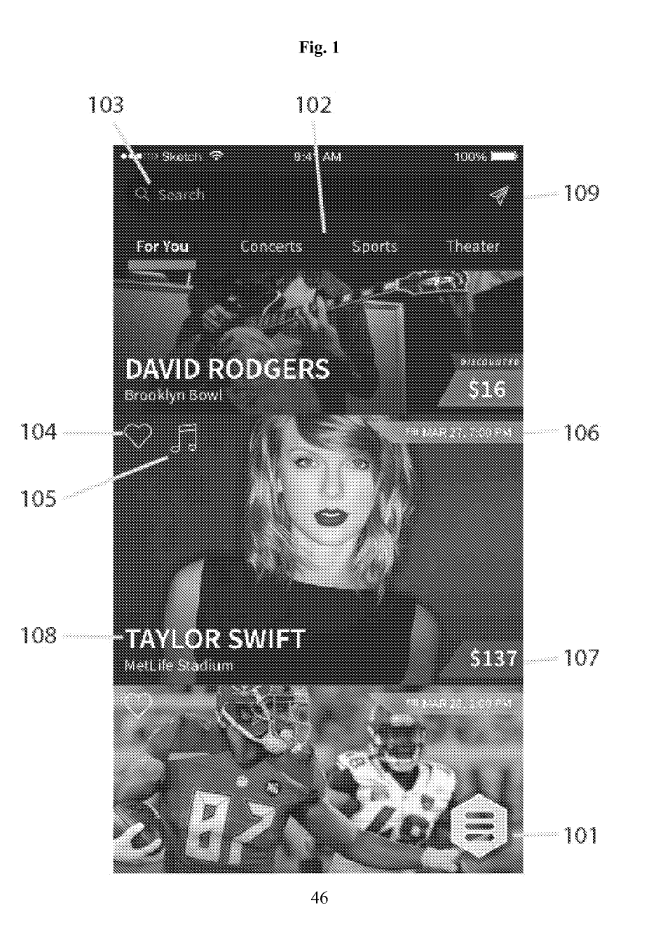

FIG. 1 depicts an example of an initial screen that a user may encounter when interacting with the ticket search application interface. This initial “browse” page may display events according to a user's location (e.g., as may be determined by the user computing device providing the application interface), a user's event preferences (e.g., as may be determined based on direct user input (e.g. through a virtual button) or based on imported data obtained with user permission from third-party sources such as Spotify or Pandora), a popularity ranking algorithm (e.g., which may identify a performer or team's “popularity” based on data obtained pertaining to average ticket price, average number of tickets sold per event, external imported rank data, or number of user's within a currently described system of this disclosure (e.g., the “Rukkus” system) that have designated said artist or team as a “favorite”, etc.), or any combination thereof.

In some embodiments, the application interface allows the user to “track” upcoming events by certain artists, teams, or arts and theater groups, or venues, or locations (e.g., cities). “Tracking” a given performer, team, or venue may increase the likelihood of a related event's display on the browse page of FIG. 1, or affect a user's ability to filter results in order to give preference to “tracked” events. In some embodiments, the user is given the option (e.g., through a virtual button 104 that may be positioned along with a set of event information) to “track” a given performer, team, or theater performance by adding them to a personal list outlining that user's event preferences.

In some embodiments, the user is given the option to disable or remove certain instances of the visual display for events pertaining to any artist, team, or theater performance.

The ticket search application interface, in some embodiments, facilitates the user to share event information with friends via email, SMS, or third-party social networking sites. The share functionality may allow users to share complete or partial information pertaining to a given event formatted as a private message, social post, or calendar “event” either within the Rukkus application or by utilizing third-party calendar applications. In further embodiments, the user is given the option to invite friends to download the app. The invite function may facilitate a promotional system whereby the user receives some incentive (e.g., points or credits, etc.) for either sending invitations or for inviting friends who then go on to make a purchase using the application.

In some embodiments, the user is able to access a direct search functionality (e.g., through a virtual button 103 that may be positioned on a top navigation bar (e.g., when the ticket search application interface is provided to a user on a touch screen of a user computing device)).

In some embodiments, the user is given the option (e.g., through a virtual button 101 that may be positioned at the top or bottom of a user interface (e.g., when the ticket search application interface is provided to a user on a touch screen of a user computing device)) to access, via a menu of features, user account information and user preferences.

In some embodiments, the user is given the option (e.g. through a virtual button 102 that may be positioned on the top navigation bar (e.g., when the ticket search application interface is provided to a user on a touch screen of a user computing device)) to alter the event display on the browse page by choosing amongst a set of broad event categories (e.g., concerts, sporting events, theater performances, etc.).

The user may be given the option (e.g., through a virtual button 105 that may be positioned along with a set of event information) to listen to complete or partial musical or comedic tracks, or to view video pertaining to the artist or team playing the given event.

In some embodiments, the event listing on the browse page includes information such as the event date 106, the event performer or event name 108, and information pertaining to the lowest ticket price available or a price range 107, and some indication of price trends for the event (e.g., whether the lowest tickets are below initial primary seller offering price or whether tickets exist only in small quantities).

In some embodiments, the user is given the option (e.g., through a virtual button 109 that may be positioned on the top navigation bar (e.g., when the ticket search application interface is provided to a user on a touch screen of a user computing device)) to change the location used to determine relevant location-based events.

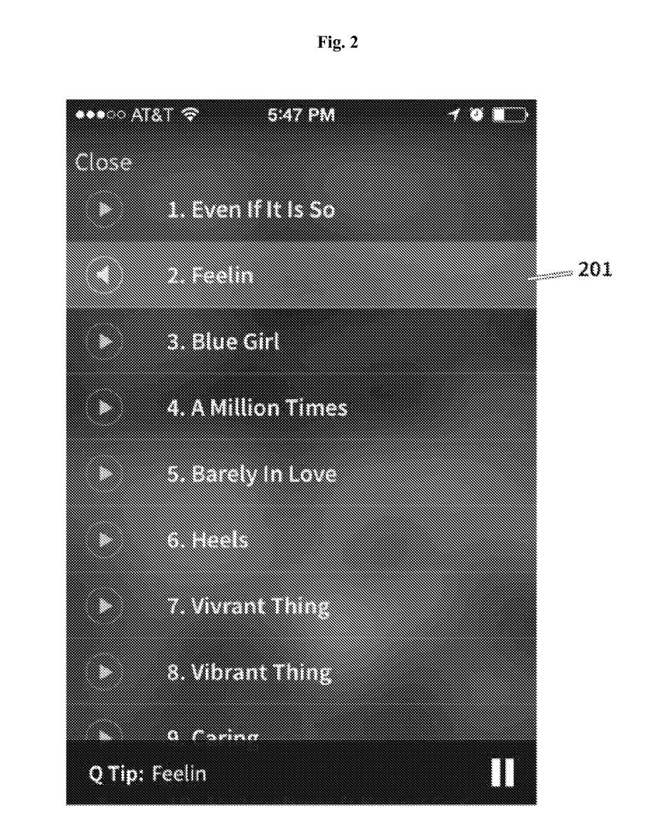

Upon clicking a virtual button 105 which accesses media from the browse page, a media listing (FIG. 2) appears either as a new page or as a window or layer on top. The media page optionally includes media information coupled with the option to play (e.g., through a virtual button 202) a given track or video. Media information is optionally arranged in row format 201 or table format.

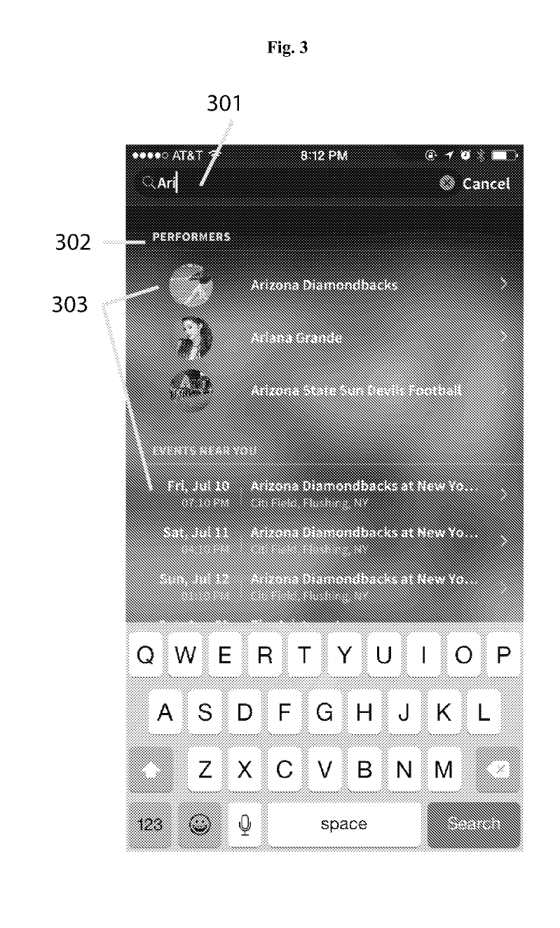

FIG. 3 is an example of a search page of a ticket search application interface whereby a user can enter parameters relating to a desired event (e.g., artist, promoter, location, venue, date, etc.) into a search field 301. In this example, specific search results 303 are grouped by one or more categories 302 (e.g., performer, event, venue, date, etc.).

User preferences and event descriptors that may be accommodated in the search for ticketed events in the ticket search application interface may include price or price range, date or date range, distance of event focal point from user, geolocation, location radius, performer or team preference or preference-based recommendation, social information, or other featuring mechanisms. The search filter system may be accommodated within the search page and/or on a separate filters page accessible from the search and/or browse page.

A user may be given the option to view or search only within a list of preferred teams, artists, and theater performances. An additional option may be offered to expand the search or view to include both the list of preferred teams, artists, and theater performances along with pertinent event recommendations which are established using an algorithm that measures the similarity of one team, artist, or performance to another.

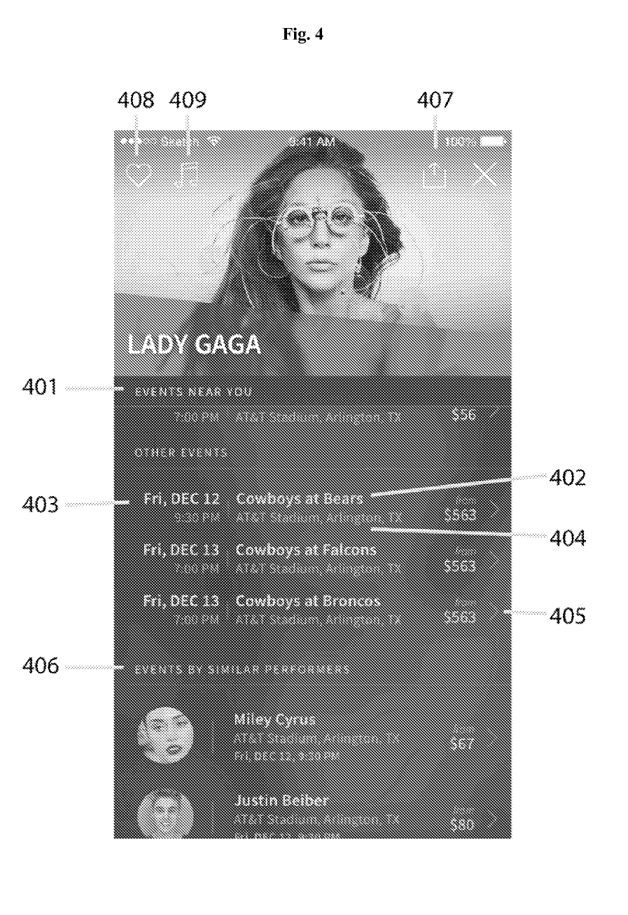

Results 303 on the search page upon selection may open a corresponding profile, which may consist of a page or group of pages related to the selected search result. For example, if an artist/performed search result 303 is selected on the search page of FIG. 3, information may be displayed in a performer profile page of FIG. 4, which may include upcoming event information that may be displayed according to an event's location relative to that of the user 401 and or by date 406, past event information, playable music tracks by the given performer. Social media and/or music may be accessed together with event info upon searching a performer, social media associated with the given performer which may include photographs and videos may be accessed (e.g., through a top navigation segmented controller or menu bar), written information pertaining to the given performer that may include biographical information, news, fan tips, or user comments. Event information may include date and or time of the event 403, the event title or performer name 402, and or the event venue or venue location 404. The event listing may include a mechanism (e.g., virtual button 405) which would allow the user to access more information pertaining to a given event. In some embodiments, a search results page includes a virtual button 407 allowing a user to access features to share an event, performer, or team profile with others via, for example, social media, instant message, email, text message, and the like. In some embodiments, a search results page includes a virtual button 408 allowing a user to mark a profile as a favorite such that a list of favorites is optionally accessed from a menu without conducting the search again. In some embodiments, where applicable, a search results page includes a virtual button 409 allowing a user to view and play media (e.g., articles, music, video, interactive media, games, etc.) associated with a particular profile (e.g., associated with a particular event, venue, team, performer, etc.).

The handling of user preferences and event descriptors may be accommodated through the use of filtering mechanisms, icons and graphical indicators, search parameters and check boxes, or other means (e.g., a user could indicate a preference for a particular category of event, which may alter the selection of upcoming events displayed to the user on the browse page). Filtered results may ensure that a more appropriate/relevant set of event data be shown to the user on the browse page, in order facilitate the event selection process.

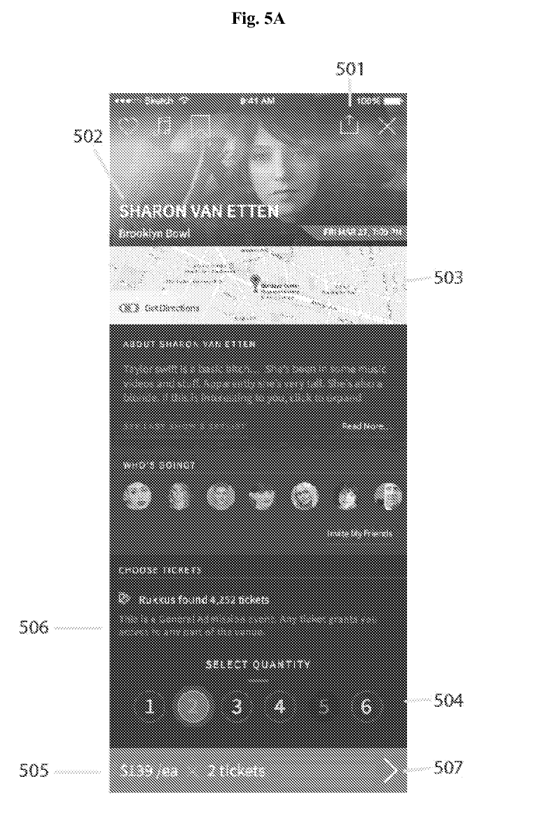

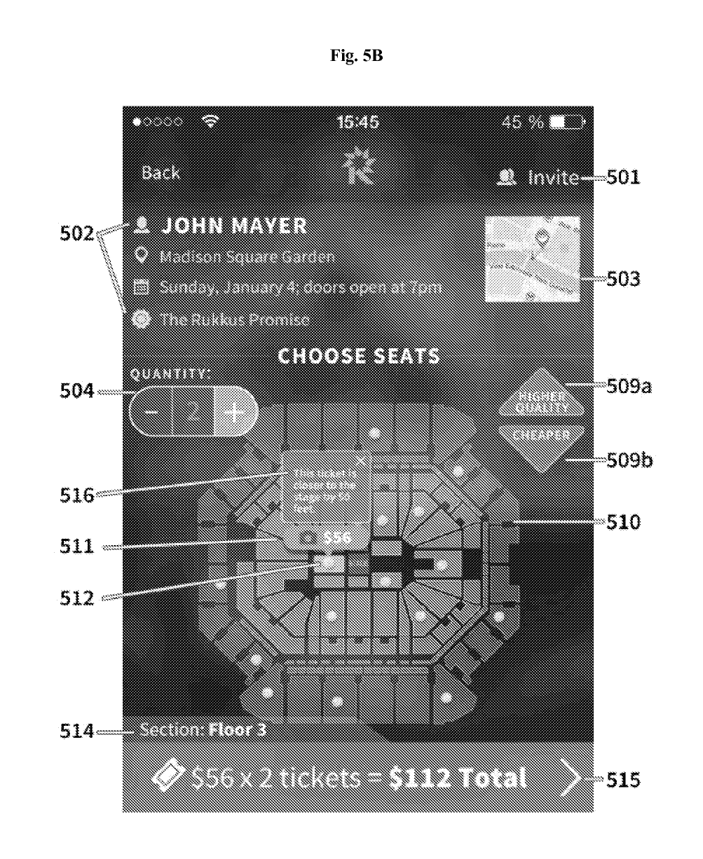

FIGS. 5A and 5B show examples of ticket pages of a ticket search application interface for a particular future event (e.g., a future event that may be selected from the page of FIG. 4), which may include buttons and or value sliders or any other suitable user interface mechanism (e.g., virtual buttons on a touch screen, mechanical buttons elsewhere on the computing device, motion or voice controlled inputs for the computing device providing the search application interface, etc.) that may allow a user to choose tickets from those available in the manner outlined below.

FIG. 5A is an example of a ticket page that might be shown in order to facilitate a user in choosing a particular ticket group for a General Admission event (i.e., an event for which there is no assigned seating), or for an event for which the system may not have or cannot access an appropriate venue map. In some embodiments, a ticket page includes a user interface element 501 allowing a user to share ticket page information with others via, for example, social media, instant message, email, text message, and the like. In some embodiments, a ticket page includes descriptive information 502 pertaining to the event such as name of the performer or team, date of the event, location of the event, and venue. In further embodiments, a ticket page includes a map 503 indicating the location of the event. In still further embodiments, a ticket page includes an indication that the event is a general admission event 506, a user interface element allowing a user to select a quantity of tickets desired 504, and a number of selected tickets and a price for each 505. In some embodiments, a ticket page includes an interface element 507 allowing a user to proceed to a checkout page to purchase selected tickets.

FIG. 5B is an example of a ticket page that might be shown in order to facilitate a user in choosing a particular ticket group for an event with assigned seating. Each ticket page of the application interface may include auxiliary descriptive information 502 pertaining to the event, which may include event time, date, geolocation information/map, description of the performer, band, or team, photos or videos of the performer, band, or team, or social information relevant to a given user based on information about a user's social connections drawn from third-party social sites. Social information may include a complete or partial listing of a user's social connections who have either expressed an interest in the event or have confirmed that they will be attending the given event using Rukkus or a third-party application, or have purchased tickets either in the Rukkus or a third-party application. Social information may be embedded directly into the ticket page or may be accessible via a virtual button indicating that the user has social connections who have expressed some kind of interest in the event. This virtual button may open a separate page or a window overlay that may include more information about the friends who have expressed interest in the event, and to what extent they have expressed their interest (e.g., “wishes to go,” “is attending,” etc.).

In some embodiments, the user is given the option to invite friends to the given event. In further embodiments, the user accesses friends or contacts either through a third-party social application or through the contacts list stored in the user's device. Invitations to the event may be pre-composed and may include complete or partial event information, information pertaining to promotional invite incentives, and may be delivered via SMS, email, or third-party social applications.

Each ticket page of the application interface may include an interactive geo map 503 which may relate the user's current location to the location of the event venue. If the user has enabled location tracking for the application, the user's location may be displayed along with the venue location in order to provide relative orientation and or facilitate direction finding. Along with written address information, the geo map gives a user a visual sense for the distance between their current location and the venue's location, which may aid in the user's decision to attend the given event.

The ticket page may include information pertaining to available tickets to the event that may include quantity 504 and price 505, and may include section, row, or seat information relating to a ticket group's seating location at the event venue 506 in FIG. 5a or 514 in FIG. 5b.

Options 504 on the page to set the quantity of desired adjacent seats may visually reflect the availability of groups of tickets at given quantities. Available quantities may be based on seller-supplied information and may be acquired along with all imported data pertaining to available ticket groups. Groupings of tickets may be set by the seller in one embodiment, or in another embodiment may be divided and or grouped by the application. Tickets may or may not be available for purchase at given quantities as tickets are may be sold in ticket groups that may not be able to be divided (e.g., due to seller preference).

The application interface may provide information pertaining to seat location at a venue, which may be accompanied by a graphical representation 510 of the venue in order to aid a user's search for tickets among those available for a given event.

The application interface may provide a full or partial list of available tickets, which a user may be able to filter using a set of relevant parameters. Filter parameters may include quantity, seat quality, seat location, and price. Filter parameters may be entered via toggles, sliders, value buttons (e.g., 504 or 509a and 509b), drop-down menus, and or entry fields which may be embedded on the ticket page or may be accessible from the ticket page via a virtual button, which may open an additional page or window overlay to display more options.

The application interface may rate available tickets to an event according to scoring algorithms or processes which may aid in a user's decision to purchase a given set of tickets. Scoring algorithms may require certain basic inputs such as quantity, which may be treated as a search requirement rather than a “filter.” “Filters” may exclude certain results from what is shown to the user and may include properties of a ticket group (e.g., price or seat location or other preferences that may be unique to a particular user and/or a particular event type). “Ticket Value” here references a relative property of a ticket group. “Ticket Value” may be assigned via an algorithm (e.g., which may be designed to take into account the higher perceived value of tickets located closer to the focal point of the arena). For example, a high score for Ticket Value may be assigned for tickets that are of higher cost yet better quality seats (e.g., closer to the stage), or for tickets that are of lower cost yet are of better quality compared to other tickets at that same price point (e.g., farther from the stage). A high score may not be assigned for tickets of higher cost that are further from the stage. If the least expensive ticket is also the best quality seat, the highest possible ticket value score may be attributed to that ticket and the user may be prompted by the system to choose that ticket as most desirable (as may generally be the case where the venue is allows for General Admission rather than using assigned seating). Ticket Value may be calculated for a given ticket group in two steps: the first calculation designates a “seat quality” value to the ticket group, and the second calculation compares the “seat quality” to the price of that ticket group to determine value. These calculations may be performed on all available ticket groups for an event prior to the user selecting any filter parameters and may therefore not be directly based on user preference in some embodiments, while in other embodiments, known preferences of the user may be taken into account during these calculations.

All ticket groups may be assigned a “ticket value/quality” value through the use of an algorithm or process (discussed further on), which may rank the value of a given ticket group relatively against all others available at a venue. In one embodiment, the “ticket value/quality” algorithm may compare only ticket groups of the same quantity; in this embodiment, quantity is a requisite input in order to display ticket group options to the user (e.g., an initial default value may be assigned in this embodiment in order to show results to the user upon first encounter with the page).

For every given ticket group quantity option, tickets may be scored by a “seat quality” algorithm, which may determine the quality of a given ticket group's seating location at the venue, and then may be assigned a ranking based on the price of that ticket group (e.g., a “ticket quality” ranking) For example, if the user chooses ticket groups of quantity two (i.e., two adjacent seats), the application may offer one set of ticket options, based on the best available ticket groups according to this “ticket quality” rating, displayed in order from the least expensive ticket group of two of a first ticket quality, to the best available “seat quality” for a group of two with lowest price for that highest ticket quality. If the user alters the quantity selector in order to search ticket groups of six, the user may see an entirely different set of options based on the availability of groups of six adjacent seats available for sale together. A user can filter results using an additional set of parameters (e.g., price range, seat quality range, seat location, etc.). Tickets may then be displayed in order to show only the best options as determined by the ticket quality/value algorithm from the lowest priced to the highest quality seat(s) within those parameters. Parameters chosen by the user may act as filters, that may allow certain ticket groups to be shown while not others. For example, if the user sets a price limit, only tickets with prices below the set limit will be shown, from among the initial set of best ticket quality ticket groups for a given quantity. In this case, tickets may not be re-evaluated by the ticket quality algorithm; instead, fewer options from within the initial results of the “seat quality” algorithm may be displayed.

Seat location or other quality determinative characteristics may be filtered using value switches, drop-down menus, or through interaction with the venue map.

The one or more algorithms or processes that may determine “seat quality” may pertain to a set of criteria that may include properties of the seat/row/section in which the ticket group is located (e.g., distance of a given ticket group to the stage/court/field (e.g., horizontally, vertically, or both), angle of variance from the ticket group to the center of the stage or field, seat position in the given row or section, quality certain zones at the particular venue, etc.), properties of the event date/time (e.g., expected weather factors on the date of the event, time of day, etc.), properties of the user (e.g., seat location preferences or information pertaining to a user's social contacts who may be in attendance, etc.) and properties of the event (e.g., popularity of the event/performer/venue, past reviews of the event that may identify particularly valuable seats, such as the fact that the performer plays an acoustic set in the back of the event space, thereby adding significant value to the seats in the back of the event space that will be as close as possible for that acoustic set), etc.).

Information about the distance and angle from a particular seat, row, or section to the venue focal point may be calculated based on data created during the construction of the venue maps themselves. Along with geometry designating the boundaries of each given section at the venue, section, row, and seat center points may have been determined and stored as retrievable data. Additional properties may be assigned during the map creation stage (e.g., indications of a given seat/row/section's exposure to weather).

For various venue configurations (e.g., involving various placements of a performance stage and or playing courts at a given venue), a focal point is determined which designates the center of activity for either the game or performance. This focal point may be determined during the map creation process and stored as retrievable data.

The distances between the seat, row, or section center points and the venue focal point, as well as the angle of variance between those two points and some venue center line may be calculated and stored as a property of the given seat, row, or section.

Additional properties of a seat, row, or section, venue properties, or event properties may be accessed from direct input or commentary from Rukkus system users, while others may be accessed from available third-party data sources. For example, information about a section in a particular venue with an obstructed view may come from cumulative commentary from users of the Rukkus application, or it may be supplied from the venue itself as data associated with ticket groups in that section. Weather data may be accessed from appropriate third-party sources and compared with known attributes of given zones of a venue (e.g. a given section may have a property “covered,” which when coupled with weather data indicating rain on the day of the event may increase the relative “seat-quality” for ticket groups within that zone). Information about a user's social contacts may be obtained from third-party social platforms, or recorded through user activity within the application. Information about a user's social contacts that may be shown to a user on the ticket page may include information about which contacts are in attendance or plan to attend, or where contacts in attendance will be sitting at the venue.

The ticket page may include buttons or interface capabilities 504 that may allow a user to choose the quantity of tickets they intend to purchase, ensuring that for a desired quantity, adjacent seating is available. These buttons may take various forms based on available space on the page or relative import granted to the quantity selection step of the ticket group selection process.

The ticket page may include virtual buttons 509a and 509b that may allow a user to view and highlight ticket groups of the highest ticket quality rating in a sequential manner from the highest ticket quality with the lowest price (lower seat quality), to the highest ticket quality with the highest seat quality (higher price).

Ticket seating location may be indicated visually using icons, pins, or some other graphical means 513 overlayed on top of a venue map as a way of linking ticket information visually to a given location on the map.

The geometric bounds of a section 512 of the venue relating to a given (e.g., selected) set of ticket information may be “highlighted,” thereby being visually differentiated using color or opacity or shading, in order to visually link a set of ticket information to a given location on the venue map.

The visual indicator may utilize a color and or shape and or size based code to illustrate the “seat quality”-price value of a given ticket group. In a given embodiment, pins may appear on the map which may have a color/size/shape corresponding to the ticket quality value associated with that ticket group.

FIG. 5B illustrates the way in which a “selected” ticket group may be displayed graphically. Information pertaining to a given (e.g., selected) ticket group may be visually overlayed on top of the venue map 510 and may include information related to the price 511 or quantity of tickets, or information related to the “seat quality” (e.g. the distance of those tickets to the stage as in element 516), the section name in which the tickets are located, or any other pertinent information that may be displayed in a fixed position on the page as in elements 514 and 515 or overlayed on top of the venue map at ticket group's corresponding location at the venue (as in element 511 and 516). This information may aid the user in choosing from amongst all ticket groups displayed during the stepwise selection process described previously.

The graphical representation of the venue and/or of a given ticket/ticket group with respect to the venue may be augmented with images that may simulate or represent the views from a given section/ticket location towards the venue's focal point (e.g., stage or main point of interest, such as the 50-yard line of a football stadium). These may be images/video generated by an operator of the system or accessed by a third-party source.

The ticket page may include information regarding company policies or standards of operation, or virtual buttons which allow a user to access similar such information (e.g., element 507).

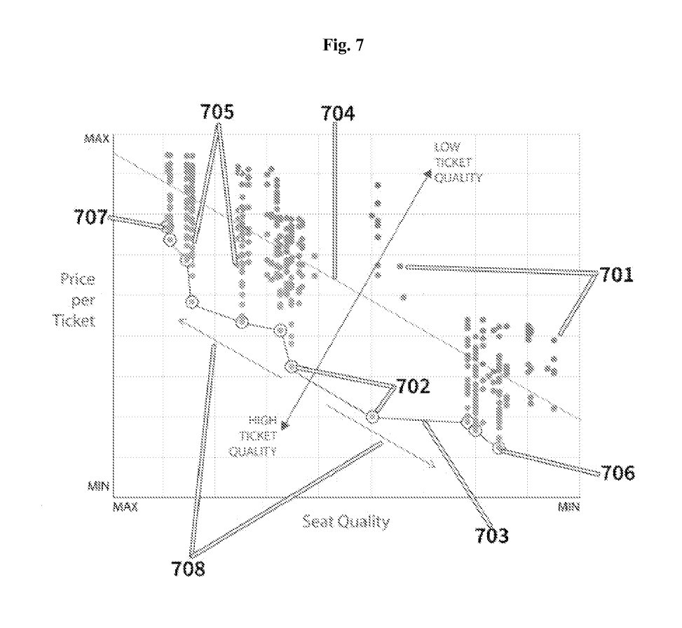

FIG. 7 graphically illustrates data that may be utilized by a procedure to determine which ticket(s) may be presented to a user (e.g., at the ticket page of FIG. 5B). This procedure may be carried out for each available ticket group quantity separately, so the graph in FIG. 7 may illustrate ticket group data for a given event for ticket groups of a given quantity (e.g., each dot may represent an available ticket group of just four tickets). The procedure can be utilized each time a user accesses the ticket page, so that information regarding ticket quality may be relative to the current availabilities of ticket groups at current prices. The y-axis of the graph may indicate the dollar price of a ticket, while the x-axis of the graph may indicate the “seat quality” (i.e., the property of a ticket group derived through the evaluation of various factors described above and/or below). Each dot on the graph may represent a given ticket or grouping of tickets (e.g., purchasable tickets that may be adjacent to one another), where the price mapped along the y-axis for that dot may be the price of a single ticket in that ticket group. The red dots 701 (e.g., the dots above the division line 704) may represent a less desirable ticket or ticket group that may be of lower or equal “seat quality” yet more expensive than some other available ticket group. The green dots 705 (e.g., the dots below the division line 704) may represent a ticket or ticket group that may have a relative higher “ticket quality” than the red dots. The line 704 may represent a trend line of all data points, and may be generated in any suitable way such as by a linear regression or exponential regression after removing outliers. The trend line 704 may be calculated for every different quantity option and each time the user is displayed available tickets, so that it may always reflect the relative trend at any given moment in time and for any given ticket group quantity. The trend line may indicate which of the given ticket groups may be of high or low “ticket value.” Those groups located furthest from the line perpendicularly downwardly towards the x-axis and leftwardly to the y-axis, may be designated as having the highest “ticket value.” The green dots 705 with the lowest price for a given “seat quality” (e.g., the circled green dots 702 that may fall along subset segment 703) may be those for which no other ticket or ticket group is cheaper and at the same or better seat quality. The arrows 708 on the graph of FIG. 7 may indicate the sequence of tickets shown from subset segment 703 as a user chooses to view “cheaper” or “higher quality” ticket groups. Segment 703 may include each ticket set considered to be the best value for tickets of a particular quality or particular quality range.

Upon encountering a ticket page initially (e.g., the ticket page of FIG. 5B), a user may be shown a given ticket or ticket group representing a “starting point”. That ticket or ticket group may be the least expensive available ticket(s) along segment 703 (e.g., dot 706 of FIG. 7), the highest quality available ticket(s) along segment 703 (e.g., dot 707 of FIG. 7), some intermediate between these two (e.g., some other ticket group among the “best available” ticket(s) 702 along line segment 703), or any other ticket(s) deemed most relevant to the user. The line 703 may sometimes be referred to as an “efficient frontier”. The starting point may be a default option that may be based on user-specific preferences or what may emerge as general user preferences (e.g., average user preferences), past purchasing behavior, or some other standard.

A user may be prompted to determine whether the given “starting point” ticket or ticket group is satisfactory or unsatisfactory based on their personal budget and personal seat quality criteria. In some embodiments, this may be accomplished using user interface inputs that may indicate a relative change in the relevant seat qualities and/or price from one ticket group to another (e.g., to a less expensive ticket or ticket group of lower seat quality or to a higher quality ticket or ticket group of higher price).

Tickets shown using this stepwise method may be a select group (e.g., one of the ticket groups 702 along segment 703), that may be chosen computationally from all available tickets for the given event in the one or more ticket databases available to the system. Tickets may be chosen from those available based on two criteria: ticket quality (e.g., distance and angle of variance from event focal point and/or any other criteria) and price (e.g., price of an individual ticket or ticket in an available ticket group).

All options shown to the user (i.e., ticket groups 702) in this step-wise manner may be located along line 703 and displayed sequentially by moving either to the left and up or to the right and down along line 703.

If the starting point ticket or any other ticket currently being shown to a user (e.g., on the page of FIG. 5B) is of too low a seat quality (e.g., too far away from the stage or playing court/field) according to a user's preference (e.g., specific tastes/desires), the user may be given the option of selecting user interface input 509a to view a more expensive ticket or ticket group which may be of higher seat quality (e.g., “closer”) in a stepwise fashion. This ticket or ticket group may be the ticket or ticket group of higher seat quality of the next lowest price according to an assigned “Ticket Quality” of FIG. 7 (e.g., of the “high ticket quality” tickets identified along line 703). The next ticket group shown to the user may be the nearest next ticket group 702 located to the left and up along line 703 (i.e., moving toward the y-axis, and away from the x-axis). When the user has reached ticket group 707, the user may lose the option 509a to view higher quality tickets (e.g., the virtual button 509a may become “disabled”), as the user has now been displayed the ticket group of highest seat quality along value line 703 and an option to view higher priced tickets would not afford the user a higher quality seat based on the seat quality algorithm or process of the system.

If the starting point ticket or any other ticket currently being shown to a user (e.g., on the page of FIG. 5B) is too costly according to a user's preference (e.g., budget), the user may be given the option of selecting user interface input 509b to view a cheaper ticket or ticket group that may be of lower seat quality (e.g., located in a section further away from the focal point than the section of the previously shown ticket) in a stepwise fashion. This ticket or ticket group may be the ticket or ticket group of the next worse seat quality and next lowest price according to an assigned “Ticket Quality” of FIG. 7 (e.g., of the “high ticket value” tickets identified along line 703). The next ticket group shown to the user may be the nearest next ticket group 702 located to the right and down along line 703 (i.e., moving away from the y-axis, and toward from the x-axis). When the user has reached ticket group 706, the user may have been shown the lowest priced ticket group and may lose the option 509b to view cheaper tickets (e.g., the virtual button 509b may become “disabled”), as lower seat quality may not result in lower price at this point.

An initial analysis may be run on the data of FIG. 7 that may exclude outliers that may be exceptionally more expensive than the given seat, row, or section desirability merits (e.g., based relatively on all other available tickets), which may allow for a more focused data set of tickets upon which further analyses may be run (e.g., for which a trend line may be able to be identified, etc.). As tickets to a given event sell or become otherwise unavailable, ticket data may be re-evaluated using the same algorithms/processes until no more tickets are available. If an outlier is, after the initial analysis, excluded from the “focused” data set, subsequent analyses may re-introduce it to the set. From the focused ticket data set, analyses may be run to determine, for any given distance from the stage, the lowest priced available ticket.

In one embodiment, the user may be shown an indication of the quality (e.g., seat quality or any other metric associated with the seat or ticket quality algorithms described above or below) gained or lost by moving from one ticket group to another 702 in this stepwise manner along line 703. These indications may take the form of a text box (e.g., element 516 of FIG. 5B) which may be overlayed over the venue map in a location corresponding to the given ticket group or it may be a fixed element on the page.

In one embodiment, all available ticket group options may be made visible to the user and may be represented graphically over the venue map at their corresponding location or in any other suitable user interface. In this embodiment, the graphical representation of the various ticket groups may be designated by a visual code of size, color, and/or shape based on the ticket quality ranking (e.g., as illustrated by the green and red dots 705 and 701 of FIG. 7).

When a user has determined which ticket group suits their particular needs, the user can then proceed to purchase the ticket(s) by selecting an appropriate user interface input (see, e.g., user input 515 of FIG. 5B or user input 508 of FIG. 5A).

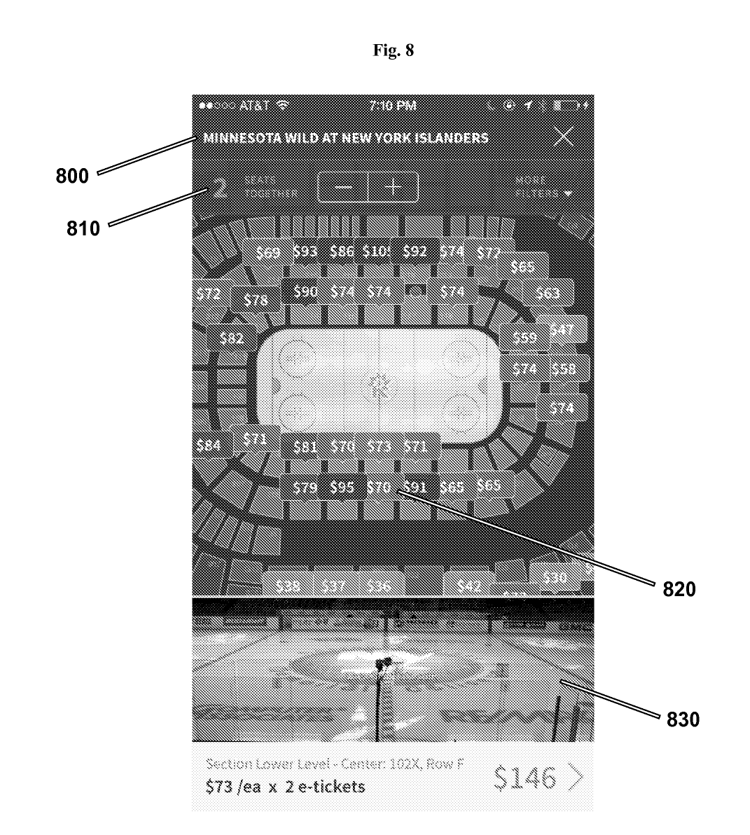

FIG. 8 illustrates an example of an event page including an interactive venue map. In this embodiment, the name of the event 800 is displayed. The user optionally indicates a number of seats desired 810 using button controls. Further in this embodiment, aggregated available ticket listings are presented on the venue map as pins, wherein within each pin, the corresponding price per ticket is displayed. This embodiment, illustrates a selected ticket listing 820, which is highlighted in a distinctive color. A preview of the view of the venue 830 from the selected ticket listing is also displayed.

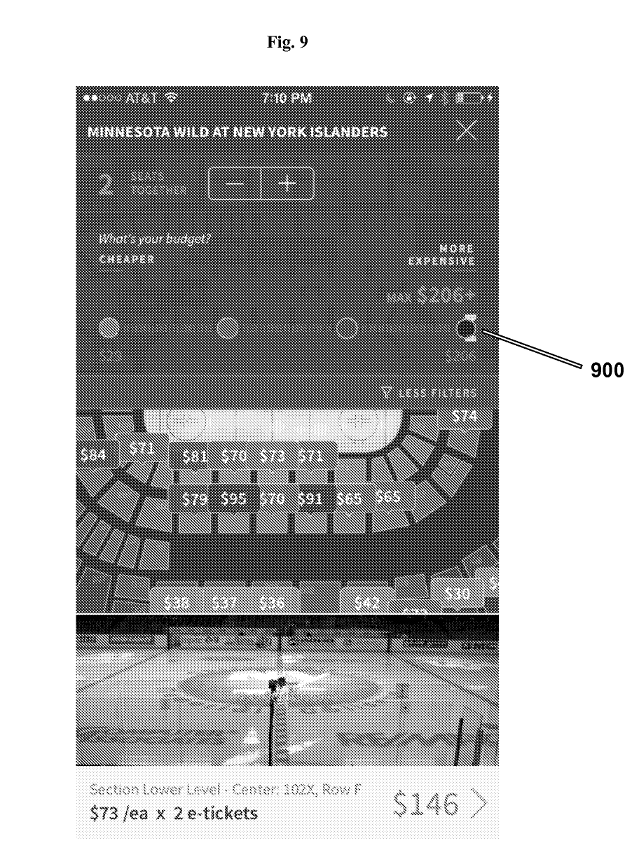

FIG. 9 illustrates an example of an event page including an interactive venue map. In this embodiment, the map includes a color-coded slider control 900 to adjust the price range of the displayed ticket listings; cheaper ticket listings are indicated with a pin in a lighter shade of the color associated with the cheaper (left) end of the slider range and more expensive ticket listings are indicated with a pin in a darker shade of the color associated with the more expensive (right) end of the slider range. As such, in this embodiment, the slider control acts as a price filter to change the ticket listings displayed.

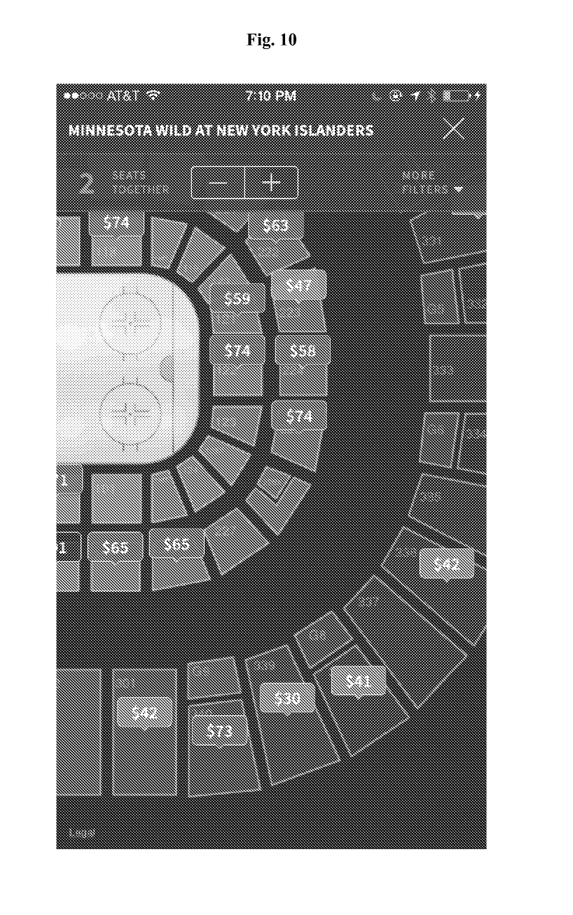

FIG. 10 illustrates an example of an event page including an interactive venue map. In this embodiment, the map is optionally zoomed (scaled) in or out by a user. The map is interactive and zooming in reveals more options and details for available aggregated ticket listings, while zooming out reveals less.

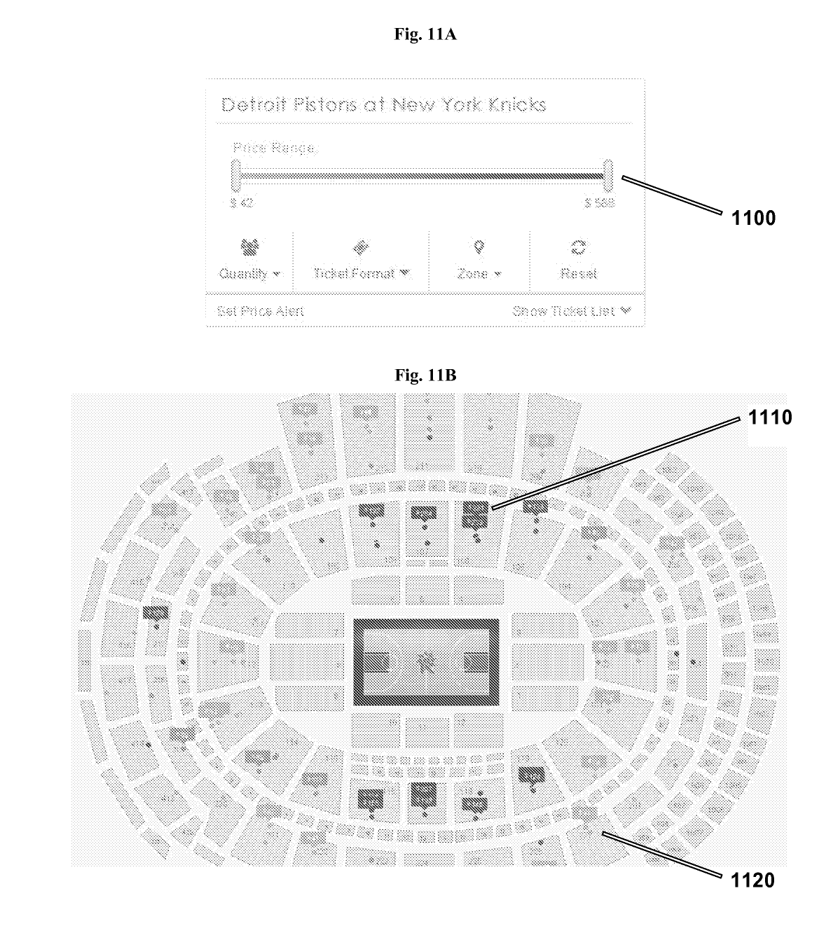

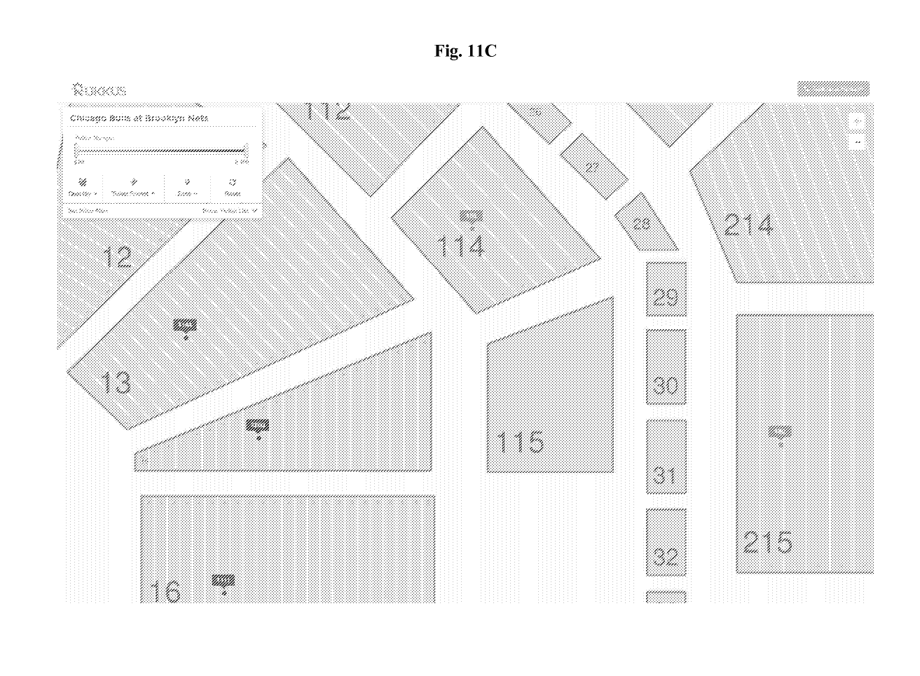

FIG. 11A illustrates an example of an interface for specifying desired ticket listing parameters. In this embodiment, the interface includes controls for a user to specify desired ticket quantity, a ticket format, a zone, a price range. In this embodiment, the price range is indicated with a two-ended slider control allowing the user to specify both minima and maxima for the price range. Moreover, in this embodiment, the slider control is color-coded. The lower end of the range is associated with a light shade of a color and the upper end of the range is associated with a dark shade of the color. In this embodiment, a venue map is populated with pins indicating available aggregated ticket listings and the pins are in colors coded to those of the indicated range.

FIG. 11B illustrates an example of an interactive venue map. In this embodiment, the map displays aggregated ticket listings as dots on the map, which are color-coded to a price range specified by a user. Preferred or recommended ticket listings are further displayed with a pin, which is also color-coded, on the venue map. In this embodiment, each pin on the venue map indicates the position, with regard to row, of the ticket listing within the section. Continuing to refer to FIG. 11B, some available aggregated ticket listings are obfuscated (e.g., diminished, obscured, or removed from the view of the user) because the ticket listings are of a higher price and lower quality than the preferred or recommended ticket listings. See also FIG. 11C demonstrating a view where a user has zoomed-in on the map to reveal greater level of detail and row-level accuracy of pin placement.

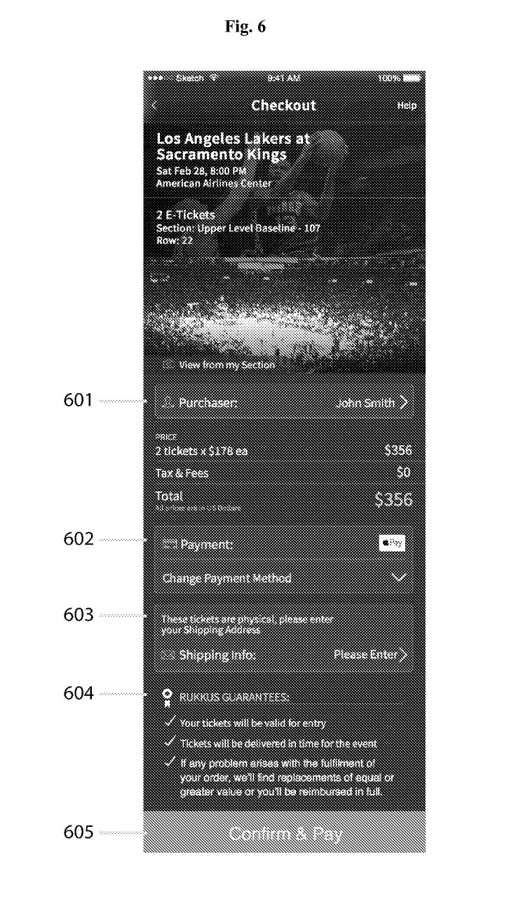

FIG. 6 illustrates an example of a checkout page of a ticket search application interface for a particular ticket/ticket group (e.g., a ticket/ticket group identified by the ticket page of FIG. 5A and/or FIG. 5B), which may include buttons and or value sliders or any other suitable user interface mechanism (e.g., virtual buttons on a touch screen, mechanical buttons elsewhere on the computing device, motion or voice controlled inputs for the computing device providing the search application interface, etc.) that may allow a user to complete a transaction for a given ticket/group.

In some embodiments, the checkout page includes one or more fields for the collection of pertinent user information that may not have been previously obtained through user login and/or through set-up of a user profile which can facilitate ticket purchase and may include purchaser information 601, a user's email field, first and last name field, credit card number/payment mechanism field 602, credit card expiration date and security code fields, and billing address field. In some embodiments, the checkout page includes fields and information relating to promotions and discounts. In some embodiments, the checkout page includes mechanisms to facilitate a user to invite friends to a given event. In some embodiments, the checkout page includes mechanisms which facilitate a user to split payment among multiple payers. In some embodiments, the checkout page includes purchaser shipping information 603. In some embodiments, the checkout page includes an embedded third-party module or in-house software to enable a user to scan their credit card using a built-in or otherwise connected camera associated with the user's computing device that may be facilitating user interaction with the system application interface. In some embodiments, the checkout page includes a written description of company policy as it pertains to in-application ticket purchases 604.

In further embodiments, the checkout page includes a recapitulation of all pertinent ticket group information which may include the total price, the price per ticket, the quantity of tickets in the given ticket group, and any breakdown of fees and or shipping costs that apply.

In still further embodiments, the checkout page includes a final purchase button 605, which enables a user to confirm their purchase. At this stage, the user is optionally able to purchase tickets from any of the vendors accessed by the application. The vendor from which the user purchases tickets may be based on the ticket group that the user chooses on the ticket page based on the criteria discussed above. The user may then be able to complete their ticket purchase without exiting the application. Payment to this third-party vendor may be intermediated by the application so that the user may complete the checkout procedure within the application. This method may ensure that checkouts happen in a more timely, streamlined manner.

The application may store pertinent payment information as user account data in order to facilitate a timely checkout for all purchases following an initial or initial log-in.

This disclosure relates to systems, methods, and computer-readable media for presenting items of value to a user and, more particularly, to systems, methods, and computer-readable media for presenting to a user for purchase only a subset of available event tickets that meet certain value criteria.

In some embodiments, presenting items of value to a user may include determining a particular event of interest and the number of tickets desired for that particular event (e.g., a single ticket or the need for four tickets to be together). This may include receiving user selections via an interface provided on a user's computing device (e.g., via a website or an application running on a user's portable computing device). In response to receiving selection of an event and number of tickets to that event, the process may include accessing information for each set of tickets matching that selected number for that selected event that are available for sale from any and all potential sources. It is to be noted that a “set” or “grouping” or “group” or “number” of tickets may include one or more tickets depending on the desired number of tickets selected. Such information may include seller information, sale price information, and details about the location or features of the ticket set (e.g., seating location, etc.).

In response to receiving such information about all available ticket sets matching the desired amount of tickets for the desired event, the process may include analyzing the ticket information to determine which sets of tickets may meet certain criteria with respect to value, such that only those sets may be presented to the user for the user to peruse for eventually purchasing one of the presented ticket sets. For example, the information about all available ticket sets matching the selected event and selected ticket number may be analyzed to determine a quality ranking for each set of tickets. This quality ranking may be determined using any suitable approach, including analysis of the location of the tickets in that set (e.g., distance of the tickets from the stage). Then, the sale price of each ticket set having a particular quality ranking may be compared such that the ticket set with the lowest sale price for a particular quality ranking may be identified. Alternatively, the sale price of each ticket set having a quality ranking that falls within a particular range of quality rankings may be compared such that the ticket set with the lowest sale price for a particular quality ranking range may be identified (e.g., each ticket set may be determined to have a quality ranking between 1 and 100, and the cheapest ticket set having a quality ranking between 1 and 10 may be identified, and the cheapest ticket set having a quality ranking between 11 and 20 may be identified, etc.).

Once the cheapest ticket set (e.g., the ticket set with the lowest sale price) has been identified for each quality ranking or range of quality rankings available for the selected event at the selected ticket number, those identified ticket sets (e.g., the most “valuable” ticket sets) may be made available to a user for purchase. In some embodiments, one of those identified ticket sets may first be presented to a user (e.g., a description of that ticket set's location and price may be presented on an output component of a user's computing device), and the user may be provided with the option to purchase that presented ticket set, the option to be presented with another one of the identified ticket sets that is of a higher quality ranking than the currently presented ticket set (e.g., an identified ticket set that has a quality ranking that is the next best quality to the ticket set currently being presented), and/or the option to be presented with another one or the identified ticket sets that is of a lower sale price than the currently presented ticket set (e.g., an identified ticket set that has a sale price that is the next cheapest to the ticket set currently being presented). The ticket set of the identified ticket sets to be first presented to a user may be any suitable ticket set, such as the cheapest ticket set of the identified ticket sets, the ticket set of the highest quality of the identified ticket sets, the ticket set of the median quality of the identified ticket sets, or any other suitable metric that may be based on characteristics of a user profile associated with the user (e.g., based on the user's past purchases).

This presentation of a particular ticket set of the identified ticket sets as well as the basic option to be presented with another ticket set that is either of higher quality or lower price enables a user to move step-wise through the identified ticket sets of value, knowing that each ticket set being presented has the best value for a particular sale price or quality ranking/range of quality rankings By selecting a “better” option or a “cheaper” option, a user may be presented with another one of the identified ticket sets that has a higher quality ranking or a lower sale price, respectively. However, each ticket set presented to a user will be of a particular value due to the analysis described above. When a new ticket set of the identified ticket sets is presented to a user (e.g., in response to selecting a “better” option or a “cheaper” option), information may be presented along with the new ticket set that may be descriptive not only of the price and possibly the location of the presented tickets within the event space (e.g., via a seating chart), but also of any other suitable information that may aid the user in determining whether or not to purchase the displayed tickets, such as why the currently displayed ticket set has a higher or lower quality ranking than the previously presented ticket set (e.g., “this ticket set is 100 feet farther away from the stage than the previously presented ticket set but is $30 cheaper,” or “this ticket set is the same distance from the stage than the previously presented ticket set but this ticket set is not afforded protection from any potential rain storms during the event unlike the previously presented ticket set but is $40 cheaper,” or “this ticket set is in the same section as your friend John's tickets, but is $20 more expensive,” etc.). Once a particular ticket set of the identified ticket set has been presented to a user that meets the user's wishes, the user may select that ticket set for purchase and the user may purchase the tickets directly from the system interface.

This quality ranking of a ticket set may be determined using any suitable information, including, but not limited to, the following: the location of the tickets in that set for the particular event (e.g., various factors may be used to analyze the quality of tickets based on their location, such as distance of the tickets from the main focal point of the event (e.g., the main stage of a concert event, distance from the 50 yard line of a football game event, etc.) or distance from other focal points of the event (e.g., a mini-acoustic stage only used during a portion of a concert event, distance from the bench of the user's team of interest in a sporting event, etc.) or with respect to protection from the elements at the event location (e.g., under a roof protecting from rain, or exposed to sunlight during the time of the event, etc.), and the like; the proximity of the tickets in that set to tickets owned by acquaintances of the user; and any combinations thereof.

A user may have a user profile that may be accumulated through the user answering questions and/or analysis of other accessible data associated with the user (e.g., from the user's social networks, etc.), such that the quality ranking of a ticket set for a particular event for one user may be at least partially based on such user data and, thus, may be different than the quality ranking of that same ticket set for that same event but for a different user.

It is understood that the steps described with respect to this process are merely illustrative and that existing steps may be modified or omitted, additional steps may be added, and the order of certain steps may be altered. For example, the processing of all available ticket sets for a selected event for a selected number of tickets may be accomplished at one or more servers remote from a user's computing device such that only information related to the identified “valuable” ticket sets and not information related to all available ticket sets for that event/ticket number may be communicated to the user's computing device for presentation. Alternatively, the processing of all available ticket sets for a selected event for all possible number of tickets (e.g., any possible number of tickets being sold as a group, be it 1, 2, 3, 4, etc.) may be accomplished at one or more servers remote from a user's computing device such that only information related to the identified “valuable” ticket sets for each possible number of tickets and not information related to all available ticket sets for that event may be communicated to the user's computing device for presentation, such that a user may quickly switch between viewing ticket sets for different ticket quantities without requiring new data to be communicated to the user's computing device from a system server.

### Geolocation

Geolocation is the identification of the real-world geographic location of an object, such as a computer, mobile smartphone, or a portable computing device such as a laptop or tablet computer. A location is suitably expressed in a number of ways including, by way of non-limiting examples, geographic coordinates (e.g., latitude and longitude), a place name (e.g., county, city, landmark, intersection, etc.), a physical street address, distance from a given location, presence within a specified radius from a given location, and a graphical depiction on a map. In some cases, geolocation involves geocoding to find associated latitude and longitude from other geographic data. In some cases, geolocation involves reverse geocoding to back code latitude and longitude coordinates to a readable address or place name.

Many methods of geolocation are suitable that utilize several underlying sources of location information. In some embodiments, a software module geolocates, for example, a consumer, a mobile processing device, or an event venue using sources of location information including, by way of non-limiting examples, GPS coordinates provided by a processing device, triangulation between mobile phone towers and public masts (e.g., assistive GPS), Wi-Fi connection location, WHOIS performed on IP address or MAC address (e.g., Wi-Fi base station MAC address), GSM/CDMA cell IDs (e.g., identification, triangulation, and multilateration), and location information self-reported by a user. In some embodiments, location information includes position (e.g., latitude and longitude), elevation, heading, speed, orientation, and combinations thereof.

In some embodiments, a software module geolocates, for example, a consumer, a mobile processing device, or an event venue by using the HTML 5 geolocation API. In light of the disclosure provided herein, those of skill in the art will recognize that the HTML 5 geolocation API is supported in Internet Explorer 9.0+, Firefox 3.5+, Safari 5.0+, Chrome 5.0+, Opera 10.6+, iOS 3.0+, Android 2.0+, and Windows Phone 7.5+. In some embodiments, a software module geolocates, for example, a consumer, a mobile processing device, or a business using methods aligned with W3C Geolocation API (available at: http://dev.w3.org/geo/api/spec-source.html). The W3C Geolocation API defines an interface to location information associated with a processing device (e.g., smartphone, tablet computer, laptop computer, etc.) hosting the implementation, such as latitude and longitude.

In some embodiments, the platforms, systems, media, and methods disclosed herein perform geolocation by one method, such as those disclosed herein. In other embodiments, the platforms, systems, media, and methods disclosed herein perform geolocation by more than one method.

In some embodiments, the geolocation of, for example, a consumer, a mobile processing device, or an event venue is accurate to within at least 100, 90, 80, 70, 60, 50, 40, 30, 20, 10, 9, 8, 7, 6, 5, 4, 3, 2, 1 or fewer kilometers, including increments therein. In further embodiments, the geolocation is accurate to within at least 1000, 900, 800, 700, 600, 500, 400, 300, 200, 100, 90, 80, 70, 60, 50, 40, 30, 20, 10, 9, 8, 7, 6, 5, 4, 3, 2, 1 or fewer meters, including increments therein.

### Digital Processing Device

In some embodiments, the systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

One, some, or all of the processes described herein may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory of a user's computing device and/or memory of a remote system server that is able to process data and send processed data to a user's computing device). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol (e.g., the computer-readable medium may be communicated to a user's computing device via a communications component (e.g., as at least a portion of an application to be loaded and run on a user's computing device and/or as at least a portion of data to be used by an application running on the user's computing device or as at least a portion of data to be presented to a user via an online web interface at the user's computing device)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

### Computer Program

In some embodiments, the systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, and methods disclosed herein include one or more databases, or use of the same. In view of the disclosure provided herein, those of skill in the art will recognize that many databases are suitable for storage and retrieval of user, event, venue, or ticket information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system for efficiently presenting location-based ticket information comprising:
a. a digital processing device comprising an operating system configured to perform executable instructions and a memory;
b. a computer program including instructions executable by the digital processing device to create an application comprising:
i. a software module configured to provide an interface presenting location-specific information about upcoming events;
ii. a software module configured to provide an interface allowing a user to indicate preferences;
iii. a software module configured to aggregate ticket listings for a selected event from primary and secondary market vendors, each ticket listing comprising a price;
iv. a software module configured to apply an algorithm identify a group of suitable ticket listings and generate a ticket value score for each ticket listing based, at least in part, on the user preferences and the price;
v. a software module configured to provide an interface presenting the ticket listings for an event as pins on a map of an event venue, each pin indicating the price and the value as determined by the algorithm, each pin positioned on the map to indicate section and row of the ticket listing; and
vi. a software module configured to obfuscate ticket listings that are a higher price and lower ticket value score than a presented or selected ticket listing.

2. The system of claim 1, wherein the user seating preferences include one or more of: price, price range, date, date range, distance of event focal point from user, location radius, venue, and performer or team.

3. The system of claim 1, wherein the ticket value score is further based, at least in part, on one or more of: properties of the seat, row, or section, properties of the event, properties of the user, and properties of the venue.

4. The system of claim 1, wherein the pins are color coded to indicate price or ticket value, the color coding utilizing a gradient of shades of a color.

5. The system of claim 1, wherein the pins comprise one or more iconographic elements to indicate price or ticket value.

6. The system of claim 1, wherein the price is presented within the pin for a ticket listing.

7. The system of claim 1, wherein the application further comprises a software module configured to present a ticket listing next best to a presented or selected ticket listing.

8. The system of claim 1, wherein the application further comprises a software module configured to present a ticket listing next best for a lower price than a presented or selected ticket listing.

9. The system of claim 1, wherein the interface presenting location-specific information about upcoming events presents media files associated with the events.

10. The system of claim 1, wherein the application further comprises a software module configured to allow a user to search, track, or share upcoming events.

11. Non-transitory computer-readable storage media encoded with a computer program including instructions executable by a processor to create an application for efficiently presenting location-based ticket information, the application comprising:
a) a software module configured to provide an interface presenting location-specific information about upcoming events;
b) a software module configured to provide an interface allowing a user to indicate preferences;
c) a software module configured to aggregate ticket listings for a selected event from primary and secondary market vendors, each ticket listing comprising a price;
d) a software module configured to apply an algorithm identify a group of suitable ticket listings and generate a ticket value score for each ticket listing based, at least in part, on the user preferences and the price;
e) a software module configured to provide an interface presenting the ticket listings for an event as pins on a map of an event venue, each pin indicating the price and the value as determined by the algorithm, each pin positioned on the map to indicate section and row of the ticket listing; and
f) a software module configured to obfuscate ticket listings that are a higher price and lower ticket value score than a presented or selected ticket listing.

12. The media of claim 11, wherein the user seating preferences include one or more of: price, price range, date, date range, distance of event focal point from user, location radius, venue, and performer or team.

13. The media of claim 11, wherein the ticket value score is further based, at least in part, on one or more of: properties of the seat, row, or section, properties of the event, properties of the user, and properties of the venue.

14. The media of claim 11, wherein the pins are color coded to indicate price or ticket value, the color coding utilizing a gradient of shades of a color.

15. The media of claim 11, wherein the pins comprise one or more iconographic elements to indicate price or ticket value.

16. The media of claim 11, wherein the price is presented within the pin for a ticket listing.

17. The media of claim 11, wherein the application further comprises a software module configured to present a ticket listing next best to a presented or selected ticket listing.

18. The media of claim 11, wherein the application further comprises a software module configured to present a ticket listing next best for a lower price than a presented or selected ticket listing.

19. The media of claim 11, wherein the interface presenting location-specific information about upcoming events presents media files associated with the events.

20. The media of claim 11, wherein the application further comprises a software module configured to allow a user to search, track, or share upcoming events.

21. A computer-implemented method of efficiently presenting location-based ticket information comprising:
a) presenting, by a computer, location-specific information about upcoming events;
b) providing, by the computer, an interface allowing a user to indicate preferences;
c) aggregating, by the computer, ticket listings for a selected event from primary and secondary market vendors, each ticket listing comprising a price;
d) applying, by the computer, an algorithm to identify a group of suitable ticket listings and generate a ticket value score for each ticket listing based, at least in part, on the user preferences and the price;
e) presenting, by the computer, the ticket listings for an event as pins on a map of an event venue, each pin indicating the price and the value as determined by the algorithm, each pin positioned on the map to indicate section and row of the ticket listing; and
f) obfuscating, by the computer, ticket listings that are a higher price and lower ticket value score than a presented or selected ticket listing.

22. The method of claim 21, wherein the pins are color coded to indicate price or ticket value, the color coding utilizing a gradient of shades of a color.

23. The method of claim 21, wherein the pins comprise one or more iconographic elements to indicate price or ticket value.

24. The method of claim 21, further comprising presenting, by the computer, a ticket listing next best to a selected ticket listing.

25. The method of claim 21, further comprising presenting, by the computer, a ticket listing next best for a lower price than a selected ticket listing.
